(19) United States
(12) Patent Application Publication
(10) Pub. No.: US 2011/0016385 A1
(43) Pub. Date: Jan. 20, 2011

(54) EDITING APPARATUS, EDITING METHOD AND EDITING PROGRAM

(75) Inventor: Nobuyuki Kasuga, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/518,026

(22) PCT Filed: Dec. 6, 2007
(86) PCT No.: PCT/JP2007/073986

§ 371 Date: Oct. 1, 2010

(30) Foreign Application Priority Data
Dec. 7, 2006 (JP) 2006-330689

(51) Int. Cl. G06F 17/00

(52) U.S. Cl. 715/243

(57) ABSTRACT

The invention provides an editing apparatus for generating a layout, comprising: a first storage means for storing materials which are the objects of a layout; a second storage means for storing attribute information as to whether the materials which are the objects of a layout are arranged automatically or arranged at a fixed position; a third storage means for storing a design rule which is a rule for generating a layout; and a layout generating means for determining arrangement of the materials which are the objects of a layout on the basis of the attribute information and the design rule.

Thereby, an editing apparatus for automatically generating a layout can provide an easy to use editing apparatus even to a user having no special knowledge of design or coloration by specifying materials arranged automatically and materials arranged at fixed positions in combination and by providing only a valid and desired layout from a plurality of the generated layouts.

### TECHNICAL FIELD

The present invention relates to an apparatus including an information processing unit and a printing unit, a method and a program, for editing a layout.

### BACKGROUND ART

Recently, information processing apparatuses such as personal computers and printers have improved in speed, function and ability to produce colors and as a result even users having no special knowledge can easily create high-quality prints.

However, in order to create nice-looking and excellent posters, bills, presentation materials or the like with a good appearance, users are required to have knowledge of or a sense of design or color.

For example, when a user creates a poster for guiding a trip, he may carry out a highly complicated procedure such as the following.
1. To determine a title (heading) of a trip.
2. To determine the distance or the schedule of the trip.
3. To determine photos suitable for a title of the trip.
4. To determine a layout of the materials (the title, the schedule, the photos etc.).
5. To determine sizes, colors, shadows and balances of the materials.

As one method for solving such problem, a technique is proposed that a user specifies the materials of steps 1 to 3 and then an information processing apparatus arranges the materials according to a specific rule and gives a plurality of layout proposals to the user, whereby steps 4 and 5 can be simplified.

For example, Japanese Patent No. 2542965 (Patent Document 1) discloses a technique in which layout formats prepared in a storage means in advance are selected according to attributes and the number of materials (elements), and the materials are automatically arranged thereby.

### DISCLOSURE OF THE INVENTION

In the prior art, however, situations occur or have occurred that the layout proposals given by an information processing apparatus are not necessarily viable for a user, or that the layout proposals are too many and thus it is difficult for a user to select from them. For example, frequently, a company name or a logo is inserted into the upper-left or lower-right area of a poster or a bill, or, characters such as “CONFIDENTIAL” and so on are inserted into the lower-right area of material for presentation. In these cases, it is intended that the material such as the characters, the logo or the like be arranged in a fixed position, and that the other freely arranged materials are preferably arranged in order not to obstruct the material at the fixed position. However, this is not realized since all the materials are automatically arranged in the prior art.

The present invention is made in consideration of the problems of the prior art described above. An object of the present invention is to provide a layout auto-generating apparatus that is convenient to use, which is a system capable of presenting such a layout sample that materials are arranged automatically and capable of arranging some of materials at a fixed position desired by the user and furthermore providing to the user only such a desired layout sample to the user that material at a fixed position and materials arranged automatically do not interfere with each other, thereby enabling a general user having no special knowledge to obtain a print of a high-quality design.

In order to accomplish the object described above, an editing apparatus according to the first invention of the present invention has the following configuration.

The editing apparatus for generating a layout, which includes a first storage means for storing the materials which are the objects of a layout; a second storage means for storing attribute information as to whether the materials which are the objects of a layout are to be arranged automatically or at a fixed position; a third storage means for storing a design rule which is a rule for generating a layout; and a layout generating means for determining arrangement of the materials, which are the objects of a layout, on the basis of the attribute information and the design rule.

Since each material which is an object of a layout has attribute information as to whether it is to be “arranged automatically” or “arranged at a fixed position” by the above means, it is possible to satisfy a desire to place a material, for example, a logo of a company name or the like at a fixed position on a paper and also to generate a layout automatically by applying a design rule.

Also, an editing apparatus according to the second invention of the present invention has the following configuration.

In other words, the editing apparatus has a specifying means for specifying the attribute information in addition to the means of the first invention.

Since a user can specify the attribute information for the materials which are the objects of a layout one by one by such the above means, it is possible for a user to instruct the editing apparatus to arrange, for example, only a title or a logo at a fixed position.

Furthermore, an editing apparatus according to the third invention of the present invention has the following configuration.

In other words, the attribute information includes whether the materials which are the objects of a layout are arranged automatically or at a fixed position and further includes any one or plural pieces of information on kind, layer information, differentiation between characters/figures/photos, position, size, color and character font of the materials which are the objects of a layout, in addition to the means of the first invention.

By such the above means, in addition to the information about an automatic arrangement or an arrangement at a fixed position, for example, when a character and a photo overlap, the character can be arranged on the photo. For example, when materials of similar color orders overlap, it is possible to additionally perform a judgment which changes the arrangement thereof and thus provide the user with a more preferable sample layout.

As is apparent from the above description, it is possible for a user to combine materials arranged automatically with materials arranged at a fixed position to generate sample layouts. In addition, it is possible to realize an editing apparatus which enables a general user having no special knowledge of design to easily obtain an excellent layout, by providing the user with a preferable sample layout from a plurality of possible sample layouts.

### BRIEF DESCRIPTION OF THE DRAWINGS

FIG. 1 is a block diagram to illustrate constituent elements of the present invention.

FIG. 2 illustrates a user interface for specifying materials and attributes thereof.

FIG. 3 illustrates layout rules and sample layouts when a “title,” a “sub-title” and a “background” are specified.

FIG. 4 illustrates layout rules and sample layouts when a “title,” a “sub-title” and a “background” are specified and a “logo” is further arranged at an upper portion in a fixed manner.

FIG. 5 illustrates layout rules and sample layouts when a “title,” a “sub-title” and a “background” are specified and a “logo” is further arranged at a lower portion in a fixed manner.

FIG. 6 is a flowchart to illustrate the exclusion of improper layouts when materials overlap.

FIG. 7 is a flowchart to illustrate the rearranging of overlapping materials in order that they do not overlap.

### BEST MODE FOR CARRYING OUT THE INVENTION

### Embodiments

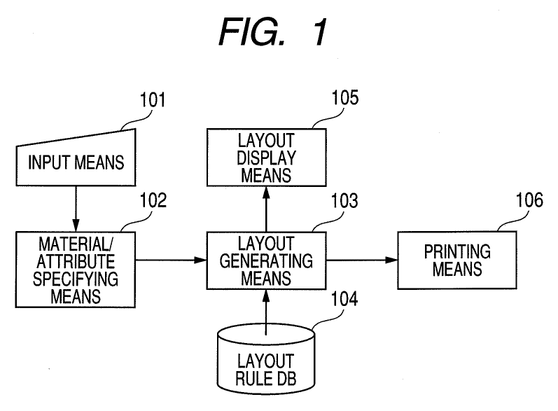

FIG. 1 is a diagram to illustrate the best mode of the present invention and is a block diagram to illustrate a configuration of a system where the present invention is applied includes an information processing unit and a printing unit.

In the same figure, the reference numeral 101 represents an input means of a user such as a mouse, a keyboard or the like, the reference numeral 102 represents a specifying means for specifying kinds of materials for a layout which is currently being created, and the attribute information (size, color, font and the like) of the material. The reference numeral 103 represents a layout generating means for generating a layout on the basis of the information of the material/attribute specifying means 102 and a rule for generating a layout, and the reference numeral 104 represents a layout rule DB for storing a plurality of layout rules. A plurality of layouts generated by the layout generating means is displayed on a layout display means 105 and then a user confirms the layouts. The layout which the user has selected is printed by a printing means 106.

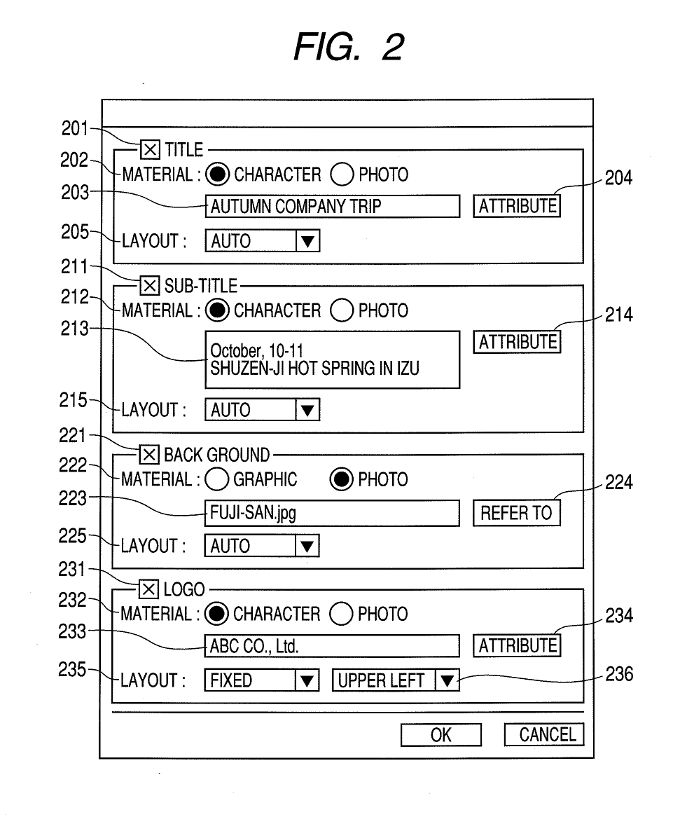

FIG. 2 illustrates an example of a user interface corresponding to the material/attribute specifying means 102. In the drawing, the reference numeral 201 represents a check box as to whether or not a “title” is displayed and for selecting validation or invalidation thereof. This is checked when a “title” is intended to be displayed. The reference numeral 202 represents a radio button for selecting the kind of display of a “title,” that is, for selecting whether it displays a character or an image. The reference numeral 203 represents a text box for entering characters to be displayed as a “title” when characters are specified using the radio button 202. The reference numeral 204 represents a button for displaying a dialogue to specify the attributes (size, color, font and the like) of the characters. The reference numeral 205 represents a combo box for switching whether a “title” is arranged automatically or it is arranged at a fixed position. Also, in the same figure, the reference numerals 212 to 215 are for specifying a “sub-title” and the reference numerals 221 to 225 are for specifying a “background.” The reference numeral 223 represents a text box for specifying an image file used as a “background.” The reference numeral 224 represents a button to display a file list for specifying an image file. The remaining elements are exactly the same as the reference numerals 201 to 205 and thus the description thereof will be omitted. In addition, the reference numerals 231 to 236 are for specifying a “logo” in the same figure. The “logo” refers to a mark of a company or a group, for example. The reference numeral 236 represents a combo box for specifying a position when a “logo” is arranged at a fixed position. Herein, although options are displayed by specific patterns such as “arrangement at an upper left portion,” “arrangement at a lower right portion” and the like, it is obviously possible to specify absolute positions/relative positions using an X/Y coordinate or the like. The remaining elements are exactly the same as the reference numerals 201 to 205 and thus the description thereof will be omitted.

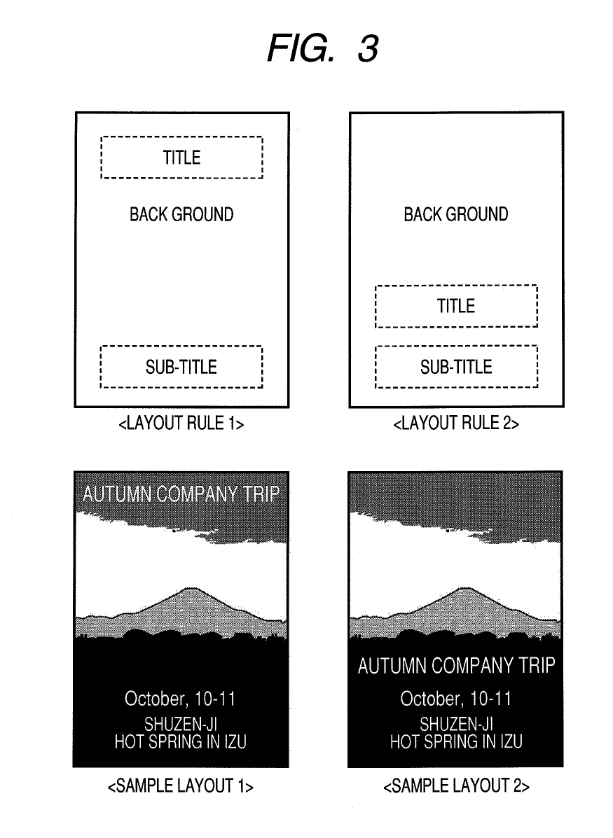

An automatic arrangement of three materials, a “title,” a “sub-title” and a “background” will be described with reference to FIG. 3. For example, a layout rule 1 and a layout rule 2 in FIG. 3 are assumed to be stored in the layout rule DB 104. When the “title” is specified as an “autumn company trip,” the “sub-titles” are specified as “October 10 to 11” and “Shuzenji hot spring in Izu”, and the “background” is specified as “Fuji-san.jpg” by the material/attribute specifying means 102, a sample layout 1 is displayed as a layout proposal on the basis of the layout rule 1 by the layout generating means 103. In addition, a sample layout 2 is displayed as another layout proposal on the basis of the layout rule 2. The user is able to select his or her preferred sample layout and print it.

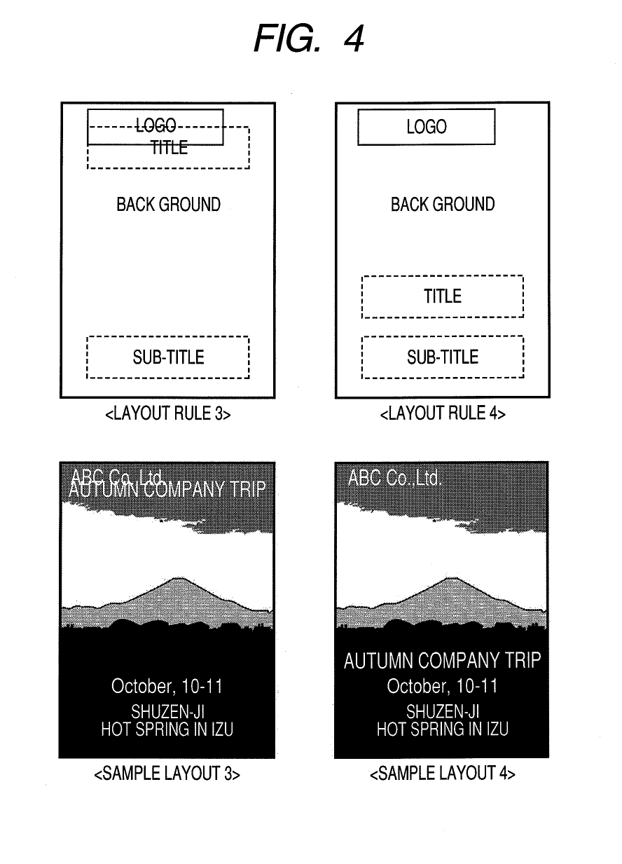

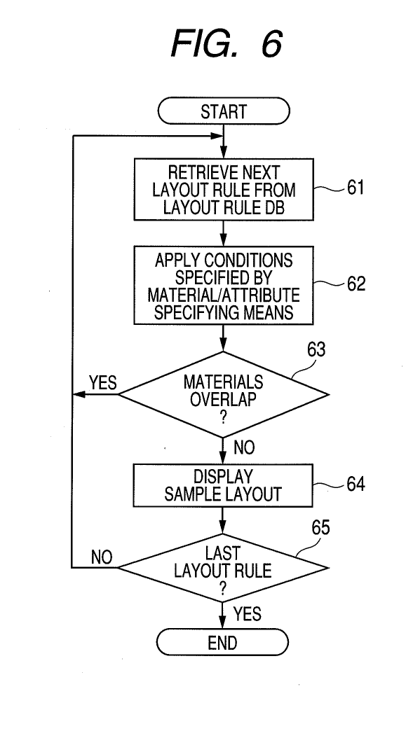

Subsequently, an example of an automatic arrangement of three materials, a “title,” a “sub-title” and a “background,” and an additional arrangement at a fixed position (upper-left) of a “logo” will be described with reference to FIG. 4. In this instance, the “logo” is arranged at the upper left portion in a fixed manner. For this reason, if a layout rule 3 is used, the “logo” and the “title” overlap each other and thus a sample layout 3 is an unsuitable image. On the other hand, if a layout rule 4 is used, a desired image without the “logo” overlapping other materials can be obtained, as in sample layout 4. According to the present invention, the layout generating means 103 proposes only a desired sample layout to a user, by the logic shown in the flowchart of FIG. 6. In FIG. 6, one layout rule is retrieved from the layout rule DB 104 at the step 61. At the step 62, a condition specified by the material/attribute specifying means 102 is applied to the layout rule. The sample layout 3 is excluded at the step 63 since the materials therein overlap at a fixed position. On the other hand, the sample layout 4 is proposed to a user as a desired sample layout at the step 64 since the materials therein do not overlap. It is possible to propose only desired sample layouts to a user by repeating the same process as many times as the number of layout rules stored in the layout rule DB.

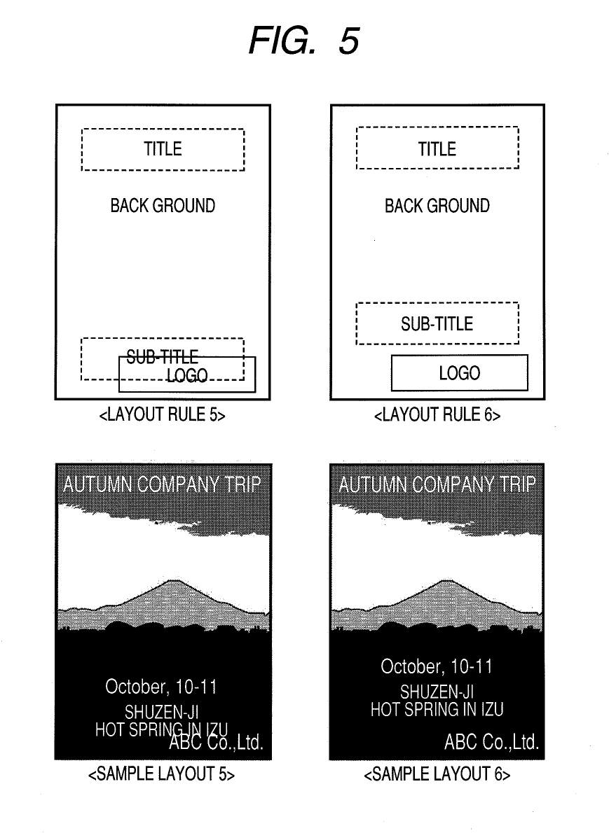

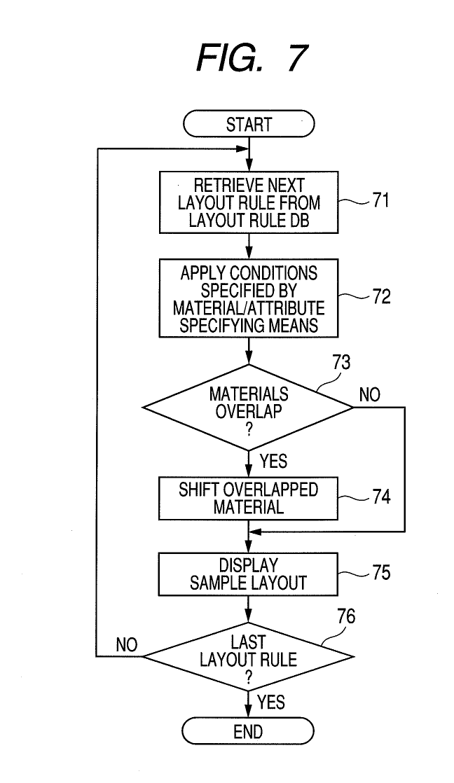

An example of an automatic arrangement of three materials, a “title,” a “sub-title” and a “background,” and an additional arrangement at a fixed position (lower-right) of a “logo” will be described with reference to FIG. 5. At this time, the “logo” is arranged at the lower right portion in a fixed manner. For this reason, if using a layout rule 5, the “logo” and the “sub-title” overlap each other and thus a sample layout 5 is an unsuitable image. According to the present invention, the layout generating means 103 solves the overlap of the materials by logic as shown in the flowchart of FIG. 7. In FIG. 7, one layout rule is retrieved from the layout rule DB 104 at the step 71. At the step 72, a condition specified by the material/attribute specifying means 102 is applied to the layout rule. The sample layout 5 has overlapping materials and the automatically arranged “sub-title”, which is overlapping the other materials, is moved upwardly at the step 74, thereby solving the overlap. It is possible to propose only desired sample layouts to a user by repeating the same process as many times as the number of layout rules stored in the layout rule DB.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-330689, filed Dec. 7, 2006, which is hereby incorporated by reference herein in its entirety.

1. An editing apparatus for generating a layout, comprising:
a first storage means for storing materials which are the objects of a layout;
a second storage means for storing attribute information as to whether the materials which are the objects of a layout are arranged automatically or arranged at a fixed position;
a third storage means for storing a design rule which is a rule for generating a layout; and
a layout generating means for determining arrangement of the materials which are the objects of a layout on the basis of the attribute information and the design rule.

2. The editing apparatus according to claim 1, further comprising a specifying means for specifying the attribute information.

3. The editing apparatus according to claim 1, wherein the attribute information includes whether the materials which are the objects of a layout are arranged automatically or arranged at a fixed position and further includes any one or plural pieces of information on kind, layer information, differentiation between characters/figures/photos, position, size, color and character font of the materials which are the objects of a layout.

4. The editing apparatus according to claim 3, wherein the kind of the materials which are the objects of a layout is any one of a title, a sub-title, a background and a logo.

5. An editing method for generating a layout, comprising:
a first storing step of storing materials which are the objects of a layout;
a second storing step of storing attribute information as to whether the materials which are the objects of a layout are arranged automatically or arranged at a fixed position;
a third storage step of storing a design rule which is a rule for generating a layout; and
a layout generating step of determining arrangement of the materials which are the objects of a layout on the basis of the attribute information and the design rule.

6. The editing method according to claim 5, further comprising a specifying step of specifying the attribute information.

7. The editing method according to claim 5, wherein the attribute information includes whether the materials which are the objects of a layout are arranged automatically or arranged at a fixed position and further includes any one or plural pieces of information on kind, layer information, differentiation between characters/figures/photos, position, size, color and character font of the materials which are the objects of a layout.

8. The editing method according to claim 7, wherein the kind of the materials which are the objects of a layout is any one of a title, a sub-title, a background and a logo.

9. (canceled)

10. A computer-readable medium storing computer-executable code for instructing a computer to perform a process comprising:
a first storing step of storing materials which are the objects of a layout;
a second storing step of storing attribute information as to whether the materials which are the objects of a layout are arranged automatically or arranged at a fixed position;
a third storage step of storing a design rule which is a rule for generating a layout; and
a layout generating step of determining arrangement of the materials which are the objects of a layout on the basis of the attribute information and the design rule.

11. The computer-readable medium according to claim 10, further comprising a specifying step of specifying the attribute information.

12. The computer-readable medium according to claim 10, wherein the attribute information includes whether the materials which are the objects of a layout are arranged automatically or arranged at a fixed position and further includes any one or plural pieces of information on kind, layer information, differentiation between characters/figures/photos, position, size, color and character font of the materials which are the objects of a layout.

13. The computer-readable medium according to claim 12, wherein the kind of the materials which are the objects of a layout is any one of a title, a sub-title, a background and a logo.
